(19) United States
(12) Patent Application Publication
(10) Pub. No.: US 2011/0268175 A1
(43) Pub. Date: Nov. 3, 2011

(54) DIFFERENTIAL PROTECTION OF A LIVE SCALABLE MEDIA

(76) Inventors: Wai-Tian TAN, Sunnyvale, CA (US); Debargha Mukherjee, Sunnyvale, CA (US); Andrew J. Patti, Cupertino, CA (US)

(21) Appl. No.: 12/771,700

(22) Filed: Apr. 30, 2010

(51) Int. Cl. H04N 11/02

(52) U.S. Cl. 375/240.01; 375/E07.026

(57) ABSTRACT

Differential protection of a live scalable media is disclosed. A first scalable encoding method is utilized for encoding a layer of a live media bit-stream, the first scalable encoding method having a first error resilience and a first bit cost. In addition, a second scalable encoding method is utilized for encoding an enhancement layer of the live media bit-stream, the second scalable encoding method comprising a second error resilience lower than the first error resilience, the second scalable encoding method further comprising a second bit cost that is lower than the first bit cost.

### FIELD

Various embodiments of the present invention relate to the field of scalable streaming media.

### BACKGROUND

In live media conferencing scenarios involving multiple clients with heterogeneous bandwidth, display resolution, or processing power, each client should be able to receive a media stream commensurate to its available resources. A one-size-fits-all approach would necessarily either curse resource-rich clients with low-quality media, or deny resource-poor clients with access.

Additionally, in media communications, there can be many types of losses, such as isolated packet losses or losses of complete or multiple frames. Breakups and freezes in media presentation are often caused by a system's inability to quickly recover from such losses. In a typical system where the media encoding rate is continuously adjusted to avoid sustained congestion, losses tend to appear as short bursts that span between one packet and two complete frames.

However, providing unequal error protection to scalable media has focused on the case when the media stream is stored rather than generated live. In such cases, common approach to unequal protection include the explicit use of network quality of service (QoS) mechanisms, where different layers are mapped to different QoS parameters for transport. For general networks without such QoS capability, unequal error protection is readily achieved by employing forward error correction (FEC) codes of different strength to the different layers. These mechanisms however, do not guarantee that the important layers, the base layer in particular is decodable when received, due to possible loss and inability to recover dependent data.

### BRIEF DESCRIPTION OF THE DRAWINGS

The accompanying drawings, which are incorporated in and form a part of this specification, illustrate embodiments of the present invention:

FIG. 1 illustrates a block diagram of live video being streamed to two heterogeneous clients, in accordance with one embodiment.

FIG. 2 illustrates a block diagram showing the high level operations of a scalable video encoder, where layer 0 (base layer) is generated by regular, non-scalable compression, in accordance with one embodiment.

FIG. 3A is a timing diagram for streaming of non-scalable video to two clients, in accordance with one embodiment.

FIG. 3B is a flowchart of a conservative layer (L) encoder operation, in accordance with one embodiment.

FIG. 3C is a flowchart of an opportunistic layer (L) encoder operation, in accordance with one embodiment.

FIG. 4 illustrates a block diagram showing the high level operations of a scalable video decoder, in accordance with one embodiment.

FIG. 5 illustrates a flowchart illustrating a process for encoding media data, in accordance with one embodiment of the present invention.

FIG. 6 is a block diagram of a computer system in accordance with one embodiment of the present technology.

The drawings referred to in the description of embodiments should not be understood as being drawn to scale except if specifically noted.

### Description of Embodiments

Reference will now be made in detail to various embodiments of the present invention, examples of which are illustrated in the accompanying drawings. While the present invention will be described in conjunction with the various embodiments, it will be understood that they are not intended to limit the invention to these embodiments. On the contrary, embodiments of the present invention are intended to cover alternatives, modifications and equivalents, which may be included within the spirit and scope of the appended claims. Furthermore, in the following description of various embodiments of the present invention, numerous specific details are set forth in order to provide a thorough understanding of embodiments of the present invention.

Differential protection of a live scalable media bit-stream is discussed herein. In one embodiment, a first scalable encoding method is utilized for encoding a layer of a live media bit-stream, the first scalable encoding method having a first error resilience and a first bit cost. In addition, a second scalable encoding method is utilized for encoding an enhancement layer of the live media bit-stream. As described herein, the second scalable encoding method uses a second error resilience lower than the first error resilience. In so doing, the second scalable encoding method has a second bit cost that is lower than the first bit cost.

For purposes of clarity and brevity, one example will describe the scalable media as video data. However, other examples of scalable media may include audio-based data, graphic data and the like. For purposes of the present Application, scalable coding is defined as a process which takes original data as input and creates scalably coded data as output, where the scalably coded data has the property that portions of it can be used to reconstruct the original data with various quality levels. Specifically, the scalably coded data is often thought of as an embedded bitstream. The first portion of the bitstream can be used to decode a baseline-quality reconstruction of the original data, without requiring any information from the remainder of the bitstream, and progressively larger portions of the bitstream can be used to decode improved reconstructions of the original data. It should be appreciated that improvement in reconstruction can be in terms of pixel fidelity, spatial resolution (number of pixels), and temporal resolution (frame rate).

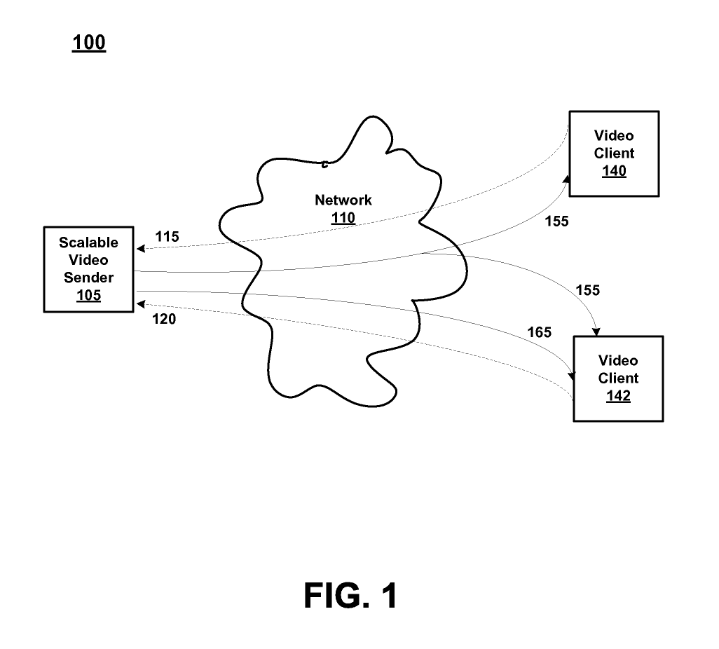

With reference now to FIG. 1, a block diagram 100 of live video being streamed to two heterogeneous clients 140 and 142 is shown. In general, heterogeneous clients may differ in many attributes including network bandwidth, compute capability, display size, and compression format support. In FIG. 1, to accommodate the different capabilities of clients 140 and 142, the video sender 105 employs scalable video, and client 140 receives only layer 0 (layer 155) while client 142 receives both layer 0 (layer 155) and layer 1 (enhancement layer 165). FIG. 1 also includes reception feedback 115 and 120 received from clients 140 and 142 respectively.

Since it is not uncommon for data network to suffer from losses from time to time, both clients 140 and 142 transmit their respective reception feedback 115 and 120 to scalable video sender 105 to advise the sender about any possibly losses observed at the clients. The sender can then undertake remedial actions in response.

The most common remedial action is retransmission of loss data. Nevertheless, for live video communications, the number of retransmissions is limited, especially when round trip delay is large (e.g., across the globe), and when low latency is desirable. Furthermore, when the number of client is large, retransmission is not scalable as one sender has to service a large number of clients. Another possible remedial action is intra-coding, which typically incur a bit-overhead of 5 to 10 times that of inter-frame coding. The goal of retransmission is to recover past loss data. A complementary remedial approach is to selectively change how future frames are generated to avoid using data corrupted by losses for prediction. For regular, non-scalable video, this approach is known as reference picture selection or newpred.

It should be noted that in general, the source can employ more than two layers, and more heterogeneous clients can be supported. It should also be noted that the separate depiction of layer 0 and layer 1 is logical in FIG. 1, and does not mean that they are necessarily transmitted separately in different packets.

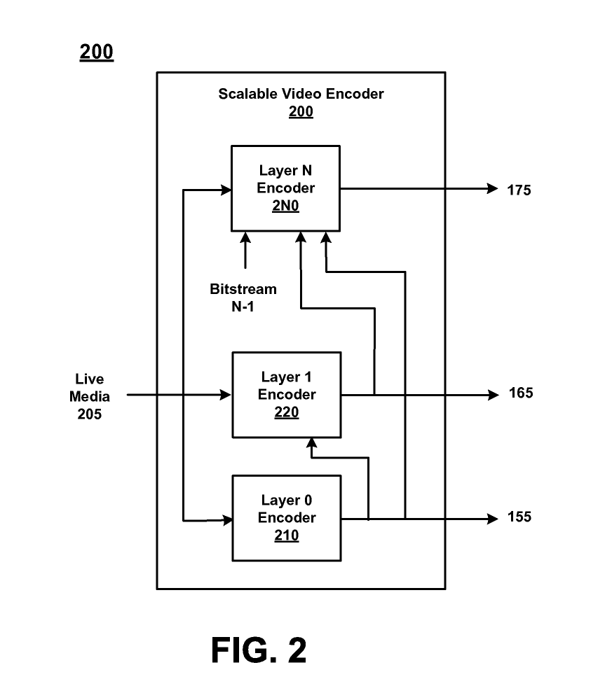

With reference now to FIG. 2, a block diagram showing the high level operations of a scalable video encoder, where layer 0 (layer 155) is generated by regular, non-scalable compression is shown. Higher layers, e.g., layer 165 and layer 175 are generated using “content” of all lower layers as input to improve compression efficiency. Since a higher layer generally depends on lower layers for decoding, preferential protection is provided to layer 0 encoder 210, since a higher layer may be undecodable if lower layers are not also received. In one scalable compression method, the “content” can be the pixels of the images at the lower layer, and the enhancement layer simply compresses the difference of the desired target frame and the image corresponding to the lower layers. It should be noted that in scalable H.264 (SVC), prediction from lower layers is not limited to pixel values, but can also predict from motion vectors and residues of the lower layers. It should also be noted that even though “content” of layers 0, . . . , N−1 can be used when compressing layer N encoder 2N0 it does not necessarily mean that layer N encoder 2N0 must use them. For example, layer N encoder 2N0 can choose not to use content of a lower layer, say N−1, and will still be decodable even without layer N−1.

### Operation of Reference Picture Selection

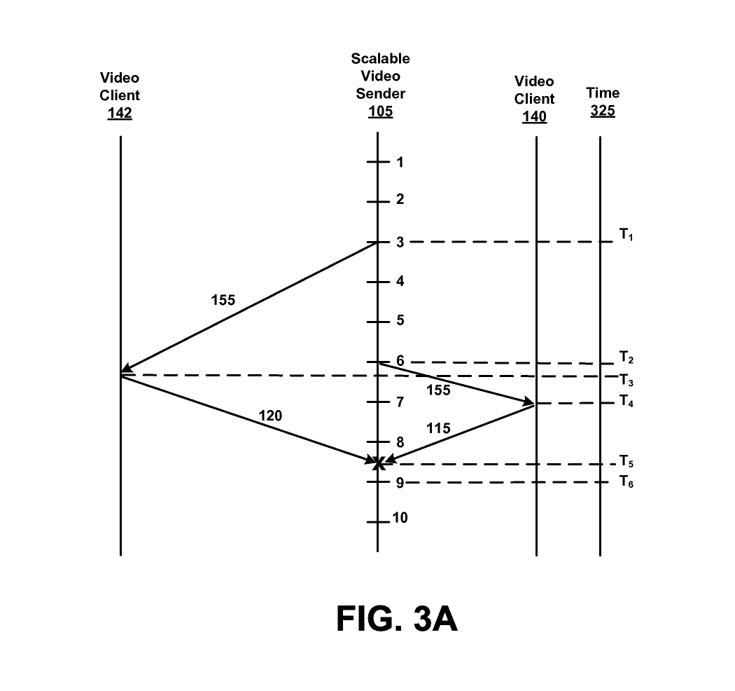

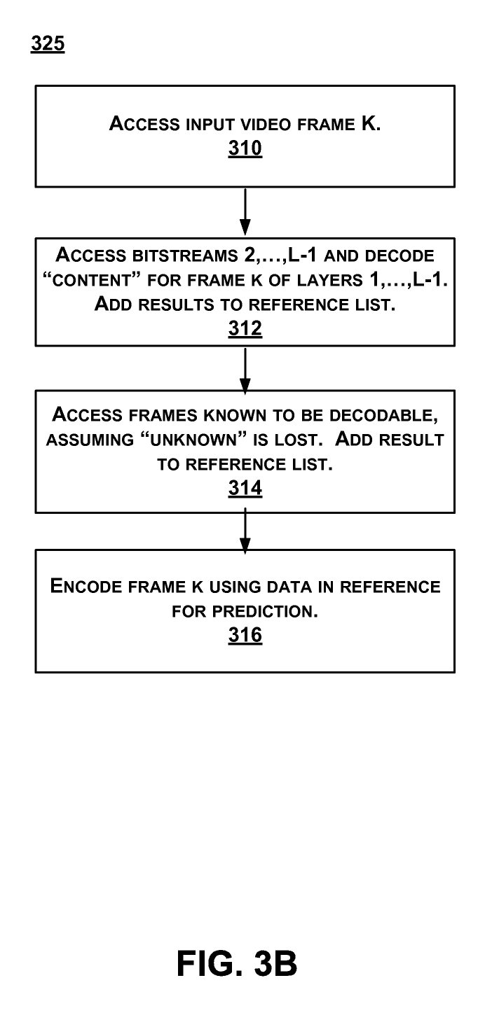

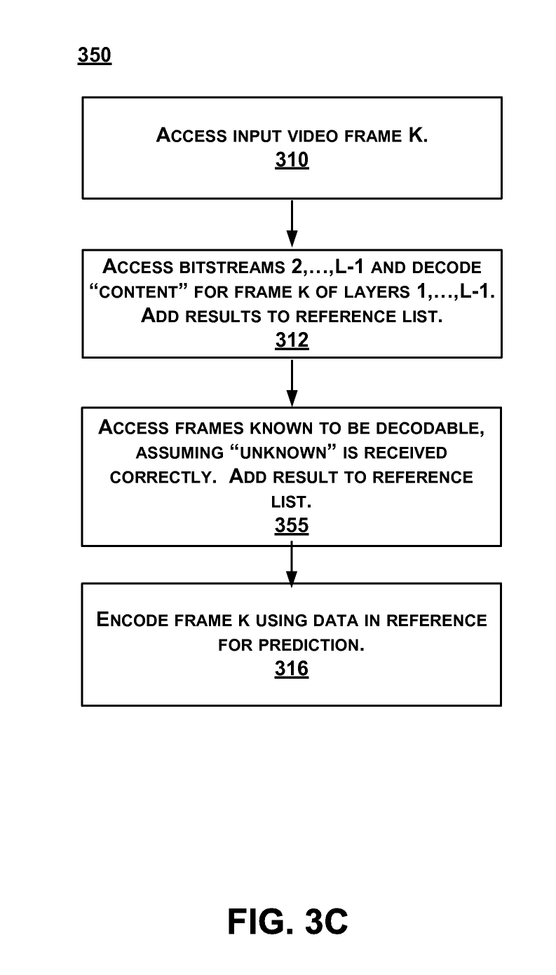

With reference to FIG. 3A, a timing diagram for streaming of non-scalable video to two clients 140 and 142 are shown. For example, the base layer of a scalable stream is compressed using normal compression methods, and is non-scalable. At time T2, scalable video sender 105 encodes and sends frame 6 to both clients. Due to transmission delays, client 140 receives frame 6 at a later time T4. Client 140 immediately sends a reception notification to the sender acknowledging receipt of frame 6. The notification is received at time T5. At time T6 when frame 9 is available for encoding at the encoder, it would have the reception statistics of frames up to frame 6, but reception status of past frames 7 and 8 will not be available until some later time. The known reception status of client 140 at scalable video sender 105 at time T6 (assuming all acknowledgements are positive) is:

| 1 | 2 | 3 | 4 | 5 | 6 | 7 | 8 | 9 |
|---|---|---|---|---|---|---|---|---|
| Y | Y | Y | Y | Y | Y | U | U | |

Where the numbers denote frame numbers, and the letters denote the corresponding reception statistics of each frame, with “Y”, “N”, and “U” indicating yes=received, no=lost, and unknown, respectively. Clearly the number of frames in “U” status depends on distance of scalable video sender 105 to client. For client 142, only reception status of frame 3 is available at time T5, so the reception status of client 142 at time T6 is:

| 1 | 2 | 3 | 4 | 5 | 6 | 7 | 8 | 9 |
|---|---|---|---|---|---|---|---|---|
| Y | Y | Y | U | U | U | U | U | |

and contains five “U” rather than two for client 140.

Reference Picture Selection is a feature in media encoding that allows a video frame to arbitrarily choose a reference frame from a specified set, rather than the conventional approach of always predicting from the last frame. This is a technique for improving compression performance, but can be employed for error resilience, illustrated in the following example, where the decoder reception state is shown from the encoder's perspective, just prior to encoding from 10.

| 1 | 2 | 3 | 4 | 5 | 6 | 7 | 8 | 9 | 10 |
|---|---|---|---|---|---|---|---|---|---|
| Y | Y | Y | N | Y | U | U | U | U | |

The basic idea is to avoid frames that are known to be corrupt. Even though frame 5 is the received at the client, it is not correctly decodable at the client (unless it is an intra-frame) since its dependent frame 4 is lost. As a result, frame 10 would be encoded using 3 as a reference, since the loss of 4 implies that 4 through 9 are all undecodable (unless there is an intra frame among 5-9). In the additional example below there is no known loss yet, and frame 5 is clearly correctly decodable at the decoder:

| 1 | 2 | 3 | 4 | 5 | 6 | 7 | 8 | 9 | 10 |
|---|---|---|---|---|---|---|---|---|---|
| Y | Y | Y | Y | Y | U | U | U | U | |

In this case, there can be two strategies to choose a reference for frame 10. In the conservative approach, the unknown frames are presumed to be lost, and 10 predicts from 5. The key advantage of the conservative approach is that a frame is always predicted from correctly decodable frames. As a result, the reception of frame 10 is sufficient to guarantee that it is correctly decodable.

It should be noted that it is not necessary to received all earlier frame for a video frame to be correctly decodable. For example, frame 4 can be lost, but frame 6 can still be correctly decodable if frame 5 is an intra-coded frame, or frame 5 does not use frame 4 for reference. Generally, the encoder determines the dependency will record its own decisions, and perform accounting to decide what data is rendered not correctly decodable for different loss patterns. The conservative approach is simply to predict from correctly decodable data only, assuming data with “unknown” status is not available for decoding.

In the opportunistic approach, the unknown frames are presumed to be fine, and 10 predicts from 9. Clearly, the conservative approach has better error resilience at the expense of high bit-cost. For example, reception of frame 10 alone is not sufficient to guarantee that frame 10 is correctly decodable; instead the additional reception of frames 6 to 8 is needed. These various techniques of employing reference picture selection for error resilience are sometimes called newpred.

It should be emphasized that in the above discussion, frame 10 is illustrated to predict from only one frame for the sake of clarity. However, in another example, under the conservative approach, frame 10 is free to use other decodable frames such as 2, 3, and 4 in addition to 5 as reference, and can change the reference frame on a per block basis. Similarly, under the opportunistic approach, frame 10 is free to use additional earlier frames such as 7, 8 as well.

It should also be emphasized that the reception status are given on a per-frame level for the sake of clarity. In another embodiment, when a compressed video frame consists of multiple packets, reception statistics may be on a per-packet basis. The same principle of the conservative and opportunistic approach can be applied, but additional bookkeeping of correspondence between packet and spatial regions may be maintained to determine the region affected by a packet loss, and error propagation tracking may also be applied to determine propagation of corrupted region over time.

### Differential Protection of Scalable Video

In one example, reference picture selection is applied only to non-scalable video, and the conservative versus opportunistic choice is determined for the entire frame. For example in scalable video, the lower layers are of higher importance than the higher layers. In one embodiment, a low bit-cost is maintained while providing error resilience by preferentially encoding a set of lower layers using a conservative approach, and the remaining higher layers using the opportunistic approach. In other words, the lower “layer encoders” are “conservative layer encoders” while the rest are “opportunistic layer encoders”, whose operations are depicted in FIGS. 3B and 3C, respectively.

With respect to FIG. 3B, a flowchart 325 of a conservative layer (L) encoder operation is shown in conjunction with one embodiment. In contrast, FIG. 3C is a flowchart of an opportunistic layer (L) encoder operation, in accordance with one embodiment. In general, FIGS. 3B and 3C assume the scalable encoder generates N layers or bitstreams. In one embodiment, the lowest K layers are generated using “conservative layer encoder”. In another embodiment, the remaining N-K layers are generated using “opportunistic layer encoder”.

At 310 of FIGS. 3B and 3C, one embodiment accesses input video frame K. For example, in the previous discussion, frame K is similar to frame 10.

At 312 of FIGS. 3B and 3C and as shown in FIG. 3A, one embodiment accesses bitstreams 2, . . . , L−1. The results are added to a reference list.

With reference now to 314 of FIG. 3B, in a conservative layer (L) encoder operation, one embodiment accesses frames known to be decodable and assumes “unknown” frames to be lost. The result including any Unknown frames being equivalent to Lost frames is added to the reference list.

In contrast, referring now to 355 of FIG. 3C, in an opportunistic layer (L) encoder operation, one embodiment accesses frames known to be decodable and assumes “unknown” frames to be received correctly. The result including any Unknown frames being equivalent to received frames is added to the reference list.

At 326 of FIGS. 3B and 3C, frame K is encoded using data in reference list for prediction. However, as stated above, although in the discussion, frame K is illustrated to predict from only one frame for the sake of clarity, in another example, under the conservative approach, frame K is free to use other decodable frames such as 2, 3, and 4 in addition to 5 as reference, and can change the reference frame on a per block basis. Similarly, under the opportunistic approach, frame K is free to use additional earlier frames such as 7, 8 as well.

It should also be emphasized that the reception status are given on a per-frame level for the sake of clarity. In another embodiment, when a compressed video frame consists of multiple packets, reception statistics may be on a per-packet basis. The same principle of the conservative and opportunistic approach can be applied, but additional bookkeeping of correspondence between packet and spatial regions may be maintained to determine the region affected by a packet loss, and error propagation tracking may also be applied to determine propagation of corrupted region over time.

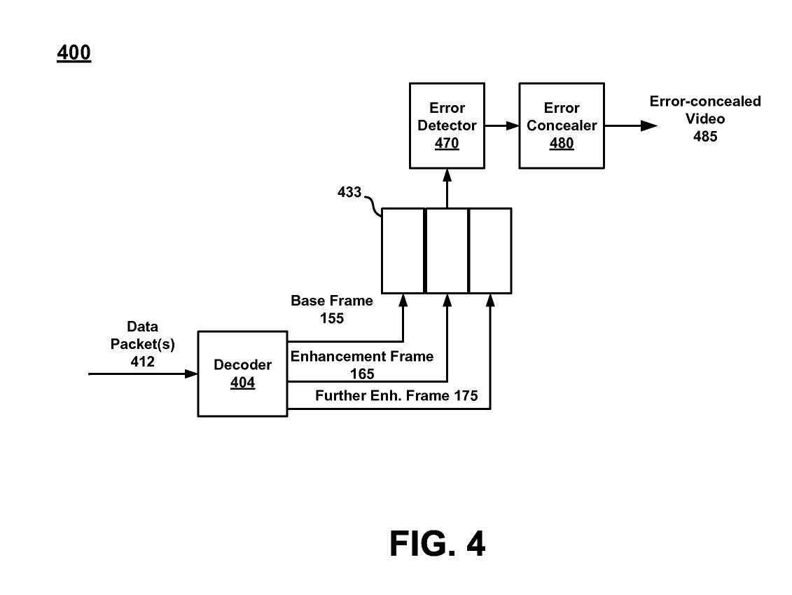

With reference now to FIG. 4, a block diagram of a decoder 404 is shown. In general, decoder 404 receives a data packet 412 containing scalably encoded video data. More specifically, decoder 404 receives the data packet 412 containing scalably encoded video data. Decoder 404 then decodes the scalably encoded regions to provide decoded regions. For example, a video frame 433 can be segmented in multiple corresponding regions such as frame 155 and one or more enhancement regions, such as enhancement frame 165 and further enhancement frame 175. The decoded regions are then assembled to provide video data as output, such as, in the form of an uncompressed video stream.

FIG. 4 additionally includes an error detector 470 configured to determine whether a frame of reconstructed media 433 includes an error. In one embodiment, after a transmission error occurs, error detector 470 performs either the opportunistic approach or the conservative approach dependent on the importance of the frame. Further detail is provided in the discussion of flowchart 400.

In various embodiments, error detector 470 is used for controlling error propagation. Moreover, any block in reconstructed media 433 with a detected discrepancy from the frame 155 that satisfies the threshold can be corrected using concealment, e.g., at error concealer 480.

With reference still to FIG. 4, error concealer 480 is configured to conceal detected error in an enhanced frame 165. In one embodiment, error concealer 480 replaces the missing portion of the enhanced frame 165 with a portion of the frame 155. In another embodiment, error concealer 480 utilizes at least a portion of the frame 155 as a descriptor in performing a motion search on a downsampled version of at least one prior enhanced frame 165. The missing portion is then replaced with a portion of a prior enhanced frame 165. In another embodiment, error concealer 480 replaces the missing portion of the enhanced frame 165 by merging the frame 155 with a selected portion of a prior enhanced frame 165.

In another embodiment, error concealer 480 may smooth at least one full resolution frame. For purposes of the instant description, smoothing refers to the removal of high frequency information from a frame. In other words, smoothing effectively downsamples a frame. For example, a reference frame is smoothed with an antialiasing filter such as used in a downsampler to avoid inadvertent inclusion of high spatial frequency during subsequent decoder motion search.

In various embodiments, a full resolution reference frame is a previously received and reconstructed enhanced frame 165. In one embodiment, the reference frames are error free frames. However, it should be appreciated that in other embodiments, the full resolution reference frame may itself include error concealed portions, and that it can be any enhanced frame 165 of reconstructed media. However, it is noted that buffer size might restrict the number of potential reference frames, and that typically the closer the reference frame is to the frame currently under error concealment, the better the results of a motion search.

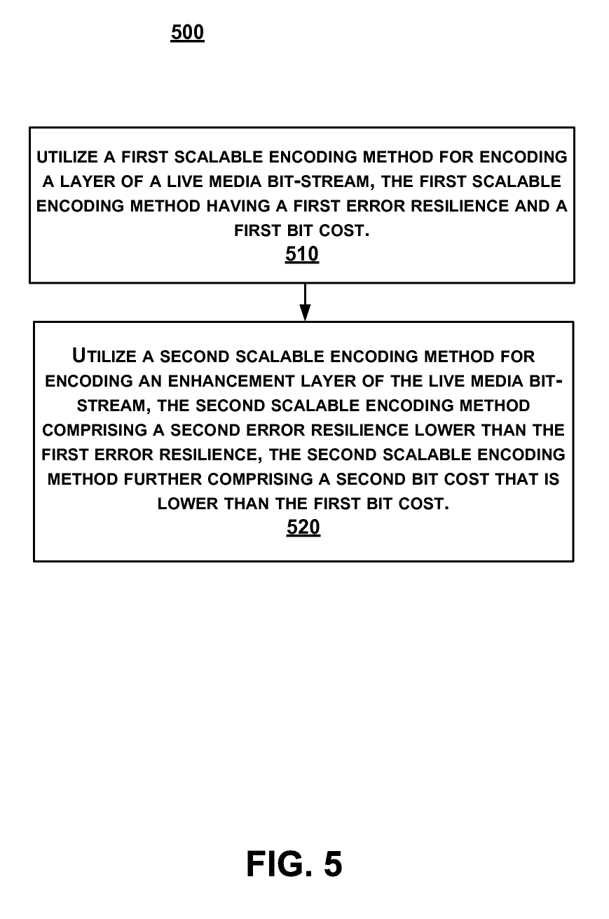

With reference now to FIG. 5, a flowchart 500 is shown in accordance with one embodiment. In one embodiment, the layered structure of the scalable bit-stream includes some layers that are more important than others and need to be protected as such.

With reference now to 510 of FIG. 5, one embodiment utilizes a first scalable encoding method for encoding a layer of a live media bit-stream, the first scalable encoding method having a first error resilience and a first bit cost.

In other words, to provide differential protection for a scalable media bit-stream in a setting of live conferencing over best-effort networks, the layer has the highly desirable property that every frame is decodable if received, without incurring the high bit-cost of intra-frames. Further, the highly robust base-layer may then used in conjunction with a “super-resolution” concealment method to partially recover any lost refinement information for improved media quality.

The important layers such as the base layer can be guaranteed to be decodable when received by exclusive use of intra coding, which incurs high bit overhead in the order of 5 to 10 times.

With reference still to FIG. 5, assuming a two layer video, the layer 155 employs newpred in the “conservative” manner In other words, frames with unknown reception statistics is assumed to be lost. This guarantees that every received frame is decodable at the expense of higher bit-cost, though still significantly less than intra-coding.

With reference now to 520 of FIG. 5, one embodiment utilizes a second scalable encoding method for encoding an enhancement layer of the live media bit-stream, the second scalable encoding method having a second error resilience lower than the first error resilience, the second scalable encoding method further having a second bit cost that is lower than the first bit cost.

For example, the enhancement layer employs newpred in the “opportunistic” manner, where frames with unknown reception statistics are assumed to be received. This reduces bit-rate for error protection. (Optionally, newpred can be not employed altogether).

When more than two layers are employed for scalable compression, the same principle can be applied so that the first one or more layers are produced in a conservative manner, and the remaining higher layers in an opportunistic manner.

At the receiving end, every base layer frame received is decodable. If an enhancement layer frame is also received, full resolution video can be decoded. However, if an enhancement layer frame is not received, a standard motion-based up-scaling or superresolution technique is employed in which the base layer is leveraged to estimate missing enhancement information from earlier received full-resolution frame(s).

In a multicast setting, the same media is transmitted to all receivers, and a received packet is defined to be one that has been received by all clients. This is especially effective for the case of a video conference with a small number of participants. In one example, the multicast setting is a network multicast. However, other multicast settings, such as application level multicast (e.g., relaying by clients), and the like may also be utilized. In addition, one embodiment is compatible with other error resilient schemes like FEC and partial retransmission.

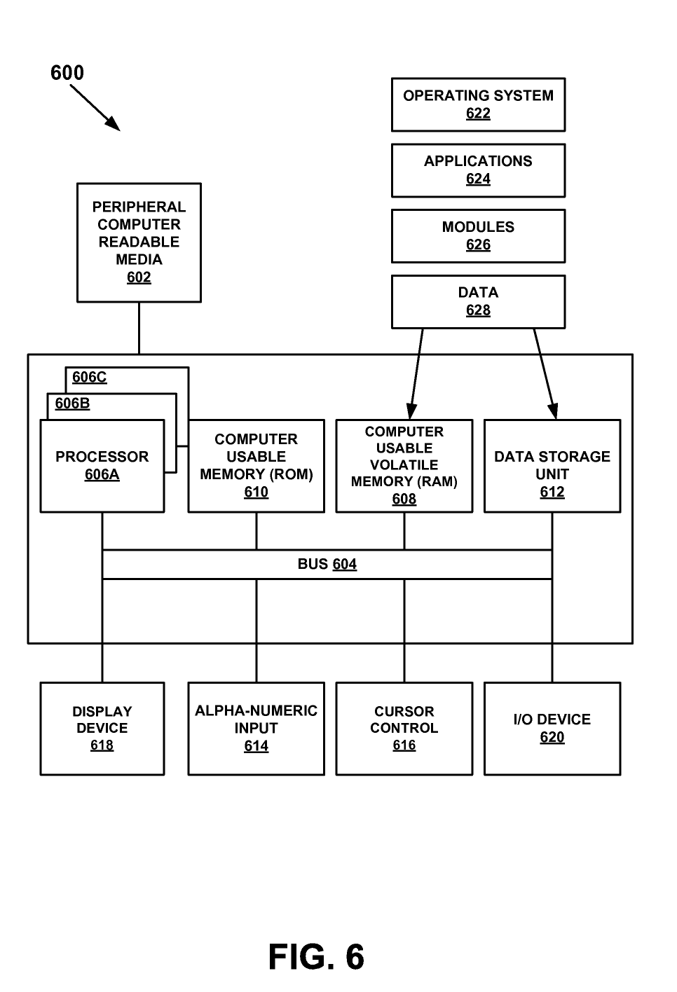

With reference now to FIG. 6, portions of the technology may be composed of computer-readable and computer-executable instructions that reside, for example, on computer-usable media of a computer system. FIG. 6 illustrates an example of a computer system 600 that can be used in accordance with embodiments of the present technology. However, it is appreciated that systems and methods described herein can operate on or within a number of different computer systems including general purpose networked computer systems, embedded computer systems, routers, switches, server devices, client devices, various intermediate devices/nodes, standalone computer systems, and the like. For example, as shown in FIG. 6, computer system 600 is well adapted to having peripheral computer readable media 602 such as, for example, a floppy disk, a compact disc, flash drive, back-up drive, tape drive, and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors.

System 600 also includes data storage features such as a computer usable volatile memory 608, e.g. random access memory (RAM) (e.g., static RAM, dynamic, RAM, etc.) coupled to bus 604 for storing information and instructions for processors 606A, 606B, and 606C. System 600 also includes computer usable non-volatile memory 610, e.g. read only memory (ROM) (e.g., read only memory, programmable ROM, flash memory, EPROM, EEPROM, etc.), coupled to bus 604 for storing static information and instructions for processors 606A, 606B, and 606C. Also present in system 600 is a data storage unit 612 (e.g., a magnetic or optical disk and disk drive, solid state drive (SSD), etc.) coupled to bus 604 for storing information and instructions.

System 600 also includes an alphanumeric input device 614 including alphanumeric and function keys coupled to bus 604 for communicating information and command selections to processor 606A or processors 606A, 606B, and 606C. System 600 also includes a cursor control device 616 coupled to bus 604 for communicating user input information and command selections to processor 606A or processors 606B, and 606C. System 600 of the present embodiment also includes a display device 618 coupled to bus 604 for displaying information. In another example, alphanumeric input device 614 and/or cursor control device 616 may be integrated with display device 618, such as for example, in the form of a capacitive screen or touch screen display device 618.

Referring still to FIG. 6, optional display device 618 of FIG. 6 may be a liquid crystal device, cathode ray tube, plasma display device or other display device suitable for creating graphic images and alphanumeric characters recognizable to a user. Cursor control device 616 allows the computer user to dynamically signal the movement of a visible symbol (cursor) on a display screen of display device 618. Many implementations of cursor control device 616 are known in the art including a trackball, mouse, touch pad, joystick, capacitive screen on display device 618, special keys on alpha-numeric input device 614 capable of signaling movement of a given direction or manner of displacement, and the like. Alternatively, it will be appreciated that a cursor can be directed and/or activated via input from alpha-numeric input device 614 using special keys and key sequence commands. System 600 is also well suited to having a cursor directed by other means such as, for example, voice commands, touch recognition, visual recognition and the like. System 600 also includes an I/O device 620 for coupling system 600 with external entities. For example, in one embodiment, I/O device 620 enables wired or wireless communications between system 600 and an external network such as, but not limited to, the Internet.

Referring still to FIG. 6, various other components are depicted for system 600. Specifically, when present, an operating system 622, applications 624, modules 626, and data 628 are shown as typically residing in one or some combination of computer usable volatile memory 608, e.g. random access memory (RAM), and data storage unit 612.

Embodiments of the present invention provide highly resilient scalable media bit-stream, with highly desirable property that each received base-layer frame is decodable. Moreover, a lower bit-rate overhead is realized as high-cost protection is only applied to the base-layer and not the enhancement layer. In addition, impact of the loss of less-protected enhancement layers is mitigated through a super-resolution error concealment technique. Thus, little encoding complexity overhead is realized. Further, decoding complexity overhead in concealment is only incurred when necessary, for example, when there are losses. The differential protection is also effective against burst losses and isolated losses for all clients involved.

Various embodiments of the present invention, differential encoding and multicasting of live scalable media streams, are thus described. While the present invention has been described in particular embodiments, it should be appreciated that the present invention should not be construed as limited by such embodiments, but rather construed according to the following claims.

What is claimed is:

1. A computer-implemented method for providing differential protection of a live scalable media, said method comprising:
utilizing a first scalable encoding method for encoding a layer of a live media bit-stream, said first scalable encoding method having a first error resilience and a first bit cost; and
utilizing a second scalable encoding method for encoding an enhancement layer of said live media bit-stream, said second scalable encoding method comprising a second error resilience lower than said first error resilience, said second scalable encoding method further comprising a second bit cost that is lower than said first bit cost.

2. The computer-implemented method of claim 1 further comprising:
utilizing said second scalable encoding method for encoding two or more enhancement layers of said live media bit-stream.

3. The computer-implemented method of claim 1 further comprising:
utilizing said first scalable encoding method for encoding two or more layers of said live media bit-stream.

4. The computer-implemented method of claim 1, further comprising:
utilizing a conservative approach when selecting reference frames for a layer such that any unknown frames are assumed lost.

5. The computer-implemented method of claim 1, further comprising:
utilizing an opportunistic approach when selecting reference frames for a such that any unknown frames are assumed received.

6. The computer-implemented method of claim 1, wherein if said enhancement layer frame is not received, said method comprises:
utilizing a standard motion-based up-scaling technique in which the layer is leveraged to estimate missing enhancement information from earlier received full-resolution frame(s).

7. The computer-implemented method of claim 1, wherein if said enhancement layer frame is not received, said method comprises:
utilizing a super-resolution technique in which the layer is leveraged to estimate missing enhancement information from earlier received full-resolution frame(s).

8. The computer-implemented method of claim 1, further comprising:
transmitting the same media to all receivers in a multicast setting; and
defining a received packet as one that has been received by all clients.

9. The computer-implemented method of claim 1, wherein said multicast level is selected from the group consisting of a network level multicast and an application level multicast.

10. A computer-implemented method for providing differential protection of a live scalable media bit-stream, said method comprising:
receiving a live scalable media data bit stream; and
scalably encoding said live media data bit stream to generate a live scalable media bit-stream, said scalably encoding comprising:
utilizing a first scalable encoding method for encoding a layer of said live scalable media bit-stream, said first scalable encoding method having a first error resilience and a first bit cost; and
utilizing a second scalable encoding method for encoding an enhancement layer of said live scalable media bit-stream, said second scalable encoding method comprising a second error resilience lower than said first error resilience, said second scalable encoding method further comprising a second bit cost that is lower than said first bit cost;
packetizing said live scalable media bit-stream to provide independently decodable scalable packets; and
decoding a packet containing scalably encoded regions to provide a decoded layer frame and an enhancement layer frame.

11. The computer-implemented method of claim 10, further comprising:
utilizing a conservative approach when selecting reference frames for a layer such that any unknown frames are assumed lost.

12. The computer-implemented method of claim 10, further comprising:
utilizing an opportunistic approach when selecting reference frames for a such that any unknown frames are assumed received.

13. The computer-implemented method of claim 10, wherein if said enhancement layer frame is not received, said method comprises:
utilizing a standard motion-based up-scaling technique in which the layer is leveraged to estimate missing enhancement information from earlier received full-resolution frame(s).

14. The computer-implemented method of claim 10, wherein if said enhancement layer frame is not received, said method comprises:
utilizing a super-resolution technique in which the layer is leveraged to estimate missing enhancement information from earlier received full-resolution frame(s).

15. The computer-implemented method of claim 10, further comprising:
transmitting the same media to all receivers in a multicast setting; and
defining a received packet as one that has been received by all clients.

16. The computer-implemented method of claim 10, wherein said multicast level is selected from the group consisting of a network level multicast and an application level multicast.

17. A computer-readable storage medium for storing instructions that when executed by one or more processors perform a method for providing differential protection of a live scalable media bit-stream, said method comprising:
receiving a live media data bit stream;
scalably encoding said live media data bit stream to generate a live scalable media bit-stream, said scalably encoding comprising:
utilizing a first scalable encoding method for encoding a layer of said live media bit-stream, said first scalable encoding method having a first error resilience and a first bit cost; and
utilizing a second scalable encoding method for encoding an enhancement layer of said live media bit-stream, said second scalable encoding method comprising a second error resilience lower than said first error resilience, said second scalable encoding method further comprising a second bit cost that is lower than said first bit cost;
packetizing said live scalable media bit-stream to provide independently decodable scalable packets; and
decoding a packet containing scalably encoded regions to provide a decoded base layer frame and an enhancement layer frame, said decoding comprising:
utilizing a conservative approach when selecting reference frames for a layer such that any unknown frames are assumed lost; and
utilizing an opportunistic approach when selecting reference frames for a such that any unknown frames are assumed received.

18. The computer-readable storage medium of claim 17, wherein if said enhancement layer frame is not received, said method comprises:
utilizing a standard motion-based up-scaling technique in which the received layer(s) are leveraged to estimate missing enhancement information from earlier received full-resolution frame(s).

19. The computer-readable storage medium of claim 17, wherein if said enhancement layer frame is not received, said method comprises:
utilizing a super-resolution technique in which the received layer(s) are leveraged to estimate missing enhancement information from earlier received full-resolution frame(s).

20. The computer-readable storage medium of claim 17, wherein said multicast level is selected from the group consisting of a network level multicast and an application level multicast.
